(19) United States
(12) Patent Application Publication
(10) Pub. No.: US 2006/0100975 A1
(43) Pub. Date: May 11, 2006

(54) Strongly-typed object oriented GUI automation framework

(75) Inventors: Brian L. McMaster, Kirkland, WA (US); Eric D. Allen, Kirkland, WA (US); William J. Bailey, Sammamish, WA (US)

Correspondence Address: AMIN & TUROCY, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 10/972,871

(22) Filed: Oct. 25, 2004

(51) Int. Cl. G06F 17/30

(52) U.S. Cl. 707/1

(57) ABSTRACT

The subject invention provides a unique system and method that facilitates classifying UI components abstracted from a computer based application in a strongly-typed manner based at least in part from a strongly-typed class framework. Methods included in the strongly-typed classes within the framework can correspond to one or more UI components found in the application. The UI components can be abstracted out and then the closest match between a UI component and a strongly-typed class in the framework can be found. Classes in the framework can be modified to create new strongly-typed classes. Once the UI components are classified in a strongly-typed manner, code can be created, albeit a lesser amount of code than otherwise would be required since the new strongly-typed classes can be derived from the framework.

### TECHNICAL FIELD

The subject invention relates generally to strongly-typed classification when coding an application and in particular to building and employing a strongly-typed class framework to create new and drive existing automation of applications for developers and testers.

### BACKGROUND OF THE INVENTION

The development of new applications and the modification of existing applications can involve a variety of procedural stages that are necessary to ensure that the application is working properly at run-time. One important stage is the testing phase of an application, wherein tests can be written or generated to determine whether the application operates as intended for an end-user. Automating the various UI (user interface) parts of the application is one valuable way to test applications.

In the past, testers utilized a quality assurance GUI (graphical user interface) architecture which was purely procedural. Such architecture includes large libraries of functional objects (e.g., functionalities). For example, suppose that the tester desires to employ a listview function to allow selecting of an item from the listview as well as clicking on an item in the listview. Selecting an item from a listview may represent one function and clicking on the item may indicate a separate function. Therefore, when writing a test, the tester has to choose and remember these separate functions in order for the listview to operate as desired for each instance in the application.

This scenario can be problematic for several reasons. First, it can be very difficult to remember what functions to use for a particular UI item. Even if the tester lists all the different methods for the different listview items, another problem can occur: whenever each function is called, the function has to be re-identified. This is because no “state” is saved in memory. That is, each function does not store a state for any item obtained. Due to the procedural nature of the conventional framework, the functions are basically static methods and thus lack any kind of organization and can be very hard to find.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to a system and/or methodology that facilitate building a strongly-typed class framework and using the framework to create new or modified technologies based upon the framework. In particular, the framework can be used to automate a plurality of UI components in an application. The framework comprises a plurality of strongly-typed classes that are representative of at least some of the major controls such as Window, Application (App), Input, Remoting, Dialog, Command, ActiveAccessibility, Logging, base controls, HTML control collection, etc. Because the framework has been established and can be easily derived from, new classes and/or new frameworks derived therefrom which are strongly-typed to specific elements within a given application can be created. Thus, the subject framework can be readily extended into new applications and technologies. From a tester or application developer's perspective, the amount of written code that would otherwise be required by conventional practices to automate new applications can be substantially reduced.

According to one aspect of the subject invention, a constructor-based system and method are provided that involve binding a UI component under test with its corresponding abstracted object. Unlike conventional techniques, this binding occurs at the time the abstracted object is constructed rather than in a separate step some time thereafter. As a result, by the time the abstracted object's constructor is completed, access to the properties of the UI component can be obtained. In general, this immediate access can be guaranteed.

According to one aspect of the invention, one or more strongly-typed classes can be utilized to abstract a plurality of UI components such as scroll bars, tool bars, menus, dialogs, window(s), as well as other UI controls. These various UI components and controls can be bound to one or more strongly-typed classes in the framework. Hence, new applications can be easily developed and the corresponding code can be readily verified for any type of errors at compile time.

According to another aspect of the invention, one or more strongly-typed classes can be modified or customized based on the user's application. Thus, new strongly-typed classes can be created and added to the framework of strongly-typed classes. In particular, the new strongly-typed classes can be derived from their respective base classes. As a result, the integrity of the “original” framework is still maintained. In new classes, however, various functionalities that are present in the original classes can be overridden as indicated by the new application.

To further support the code writing process that can take place while developing and testing applications, suggestions can be made to assist the user (e.g., tester) as the code is being written. For example, when the user is typing a particular key word, a list of available options for the particular word can be shown to the user. The user can then select from the list. This type of smart assistance can enhance the overall integrity of the code and mitigate syntax or semantic errors. Other similar options to improve the code include automatically filling or correcting a key word or phrase as the user is typing it. The suggestions can be based on a data bank of key words associated with a set of strongly-typed classes. Additionally, artificial intelligence can be employed to facilitate making suggestions. For example, the listing of suggestions can be optimized based on errors or mistakes that are tracked and/or learned. Similar, successful “pairings” can be learned and remembered as well. It should be appreciated that the various kinds of suggestions can be ignored or overruled by the user according to user preferences.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a strongly-typed classification system in accordance with an aspect of the subject invention.

FIG. 2 is a block diagram of a strongly-typed classification system in accordance with an aspect of the subject invention.

FIG. 3 is a block diagram of a strongly-typed classification system in accordance with an aspect of the subject invention.

FIG. 4 is a schematic block diagram of a system that facilitates coding an application based in part on a strongly-typed class framework in accordance with an aspect of the subject invention.

FIG. 5 is a schematic control diagram indicating one or more strongly-typed classes associated with the control, whereby the diagram represents a portion of the strongly-typed framework in accordance with an aspect of the subject invention.

FIG. 6 is a schematic control diagram indicating one or more strongly-typed classes associated with the control, whereby the diagram represents a portion of the strongly-typed framework in accordance with an aspect of the subject invention.

FIG. 7 is a schematic control diagram indicating one or more strongly-typed classes associated with the control, whereby the diagram represents a portion of the strongly-typed framework in accordance with an aspect of the subject invention.

FIG. 8 is a schematic diagram indicating one or more strongly-typed classes associated with an application that is based at least in part upon the subject strongly-typed class framework in accordance with an aspect of the invention.

FIG. 9 is a flow chart illustrating an exemplary methodology that facilitates classifying UI components for an application in a strongly-typed manner based at least in part upon the subject strongly-typed class framework in accordance with an aspect of the subject invention.

FIG. 10 is a flow chart illustrating an exemplary methodology that facilitates classifying UI components for an application in a strongly-typed manner based at least in part upon the subject strongly-typed class framework in accordance with an aspect of the subject invention.

FIG. 11 is a flow chart illustrating an exemplary methodology that facilitates creating code for automation of an application based at least in part upon the subject strongly-typed class framework in accordance with an aspect of the subject invention.

FIG. 12 illustrates an exemplary environment for implementing various aspects of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

The subject invention can incorporate various inference schemes and/or techniques in connection with strongly typing a plurality of UI components from an application or program based on one or more strongly-typed classes and creating tests and/or writing code related thereto. For example, inference schemes and/or artificial intelligence can be employed to correlate or bind a UI component with a strongly-typed class to effectively automate the UI component.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The subject invention provides a framework that uses strongly-typed classes to abstract a plurality of UI components such as windows, dialogs, buttons, treeviews, as well as other different UI controls. The strongly-typed classes can be thought of as building blocks from which other strongly-typed classes can be built. Program developers and testers can inherit and extend these building blocks to abstract new technologies and combine them in a variety of ways to represent their application's UI in a strongly-typed manner. As a result of doing so, errors can be determined at compile time by a programmer or tester rather than at run-time by an end-user. Overall, the performance of an application can be optimized.

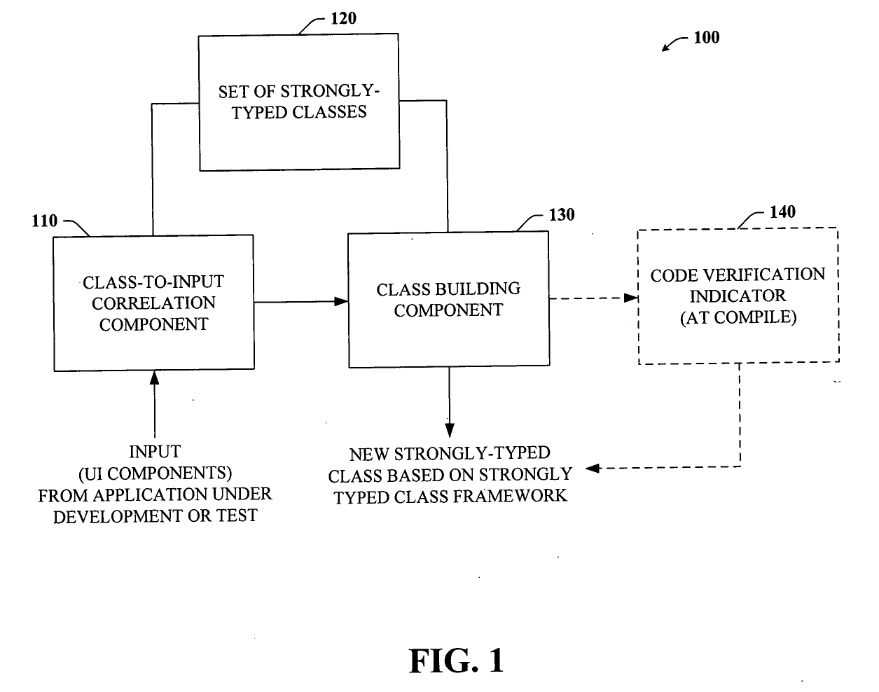

Referring now to FIG. 1, there is a general block diagram of a classification system 100 that facilitates classifying controls and/or UI components in a strongly-typed manner in accordance with an aspect of the subject invention. The system 100 includes a class-to-input correlation component 110 that receives input from a user (e.g., developer or tester). Examples of the input can include but are not limited to one or more UI components associated with an application under development or test. The correlation component 110 can identify the UI components and then correlate them to properties or methods of any one strongly-typed class within a set of strongly-typed classes 120. As new associations are determined between the UI components and the existing strongly-typed classes, a building component 130 can create one or more new strongly-typed classes that are derived from the existing set of classes. The building component 130 can reference and build upon the existing set of classes so that the framework is followed for consistency and uniformity, as appropriate, among the classes.

In general, typing classes in a strongly-typed manner provides a generic base from which many more particular or specialized functionalities can be derived. By maintaining this connection or interrelationship between the derived methods and their “original” versions, the new (derived) methods can rely on information (e.g., code) that has already been gathered or produced. In terms of coding an application, original items that have already been strongly-typed into a class do not need to be re-identified and coded. As a result, substantial amounts of time can be saved for the developer and/or tester.

Furthermore, the coded application or test can be compiled to readily determine whether any errors are present in the code. Any errors that are found can be revealed by way of a code verification indicator 140. The indicator 140 can provide an alert, warning, or some other notification (e.g., pop-up window) to inform the user of an error(s) that has been discovered. The indicator 140 can be optional depending on user preferences. Finally, any new and/or derived strongly-typed classes can be added to augment the existing set of strongly-typed classes.

In practice, for example, the system 100 can be referred to as a constructor-based system that provides binding between the UI component being tested and the abstracted object when the abstracted object is created or constructed. This occurs in a single step or process as opposed to traditional systems or methods that typically require making a separate, explicit call (e.g., create) to give the abstracted object a connection to a “real” thing (e.g., UI component such as ListView). According to this aspect of the subject invention, access to the properties of the ListView can be guaranteed upon creation of the abstracted object. The traditional approach allows the creation of the abstracted object without an actual binding to the object that is being abstracted. Unfortunately, this approach can lead to problems later since access to the properties can be delayed.

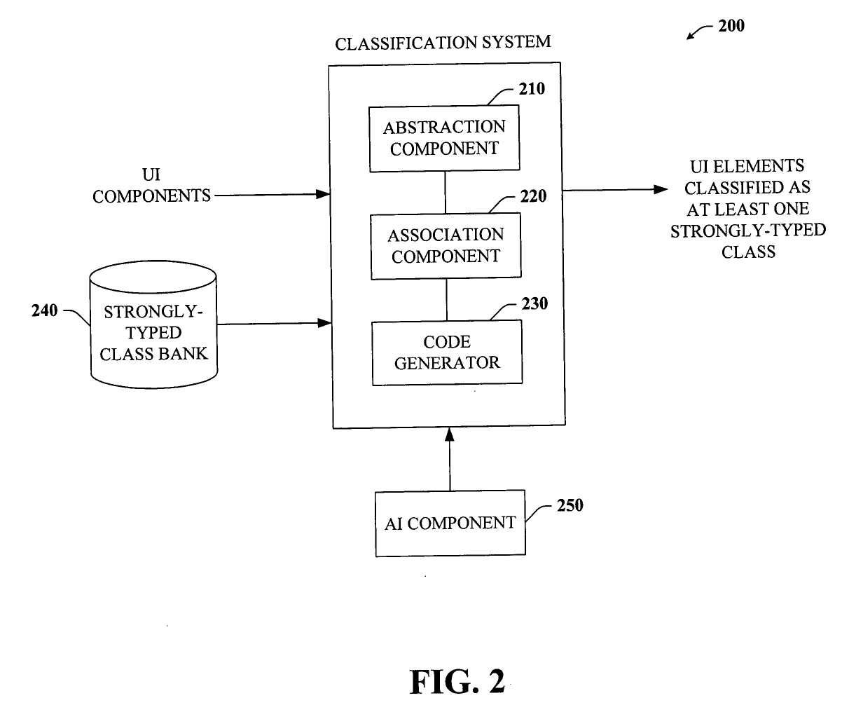

Turning to FIG. 2, there is illustrated a block diagram of a classification system 200 that can be employed to classify new applications in a strongly-typed manner according to a strongly-typed class framework. The classification system 200 includes an abstraction component 210, an association component 220, and a code generator 230. The abstraction component 210 can abstract one or more UI components from an application, for example, to identify the functionalities of the various UI components. Following, the UI components can be associated with corresponding objects, properties, or methods in the strongly-typed class bank 240. When a suitable match is found, the UI component can be linked to the respective class. Once this is determined, a user can write the code according to the recently made associations.

Additionally, an artificial intelligence (AI) component 250 can be employed to further enhance the association and/or code writing process. More specifically, the AI component 250 can learn which associations create the least number of errors or no errors at all to improve the performance of future associations. Furthermore, the AI component 250 can be trained by a user, for instance, on how to determine associations or match-ups between any given UI components and the bank of strongly-typed classes. The AI component can provide an overall optimization of the classification system 200.

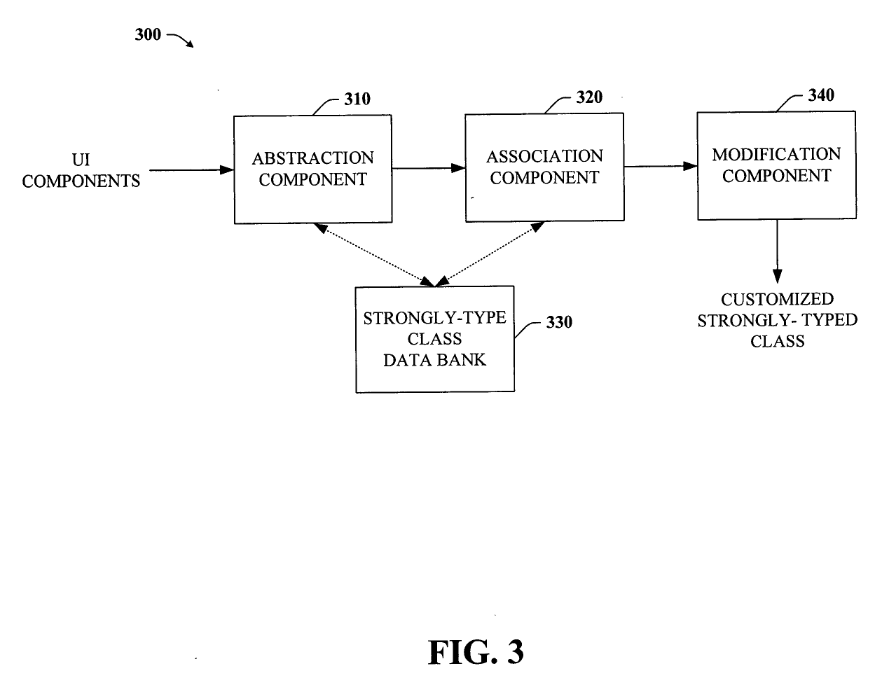

Alternatively or in addition, the framework can be built upon by creating new strongly-typed classes derived therefrom. Referring now to FIG. 3, there is a classification system 300 that allows for creating customized strongly-typed classes. The classification system 300 is similar to that of the system 200 discussed with respect to FIG. 2, supra. In particular, the system 300 includes a similar abstraction component 310 and an association component 320 that both draw information from a strongly-typed class data bank 330 to facilitate making the correct or most accurate associations between one or more UI components and the existing strongly-typed classes.

Unlike the classification system 200 in FIG. 2, the system 300 also includes a modification component 340 that is operatively connected to the association component 320. The modification component 340 essentially can modify the strongly-typed class or some portion thereof according to the UI components abstracted from an application under development or test. The modifications can be made such that the “original” strongly-typed class remains intact and the modified (new) class is merely derived therefrom. There can be several levels of inheritance between classes. For instance, one strongly-typed class can be derived from another which is derived from yet another, etc. Furthermore, derived classes can override certain behaviors of their base classes in addition to augmenting the types of behaviors. In the end, a customized strongly-typed class can result to assist in the automation of the new application.

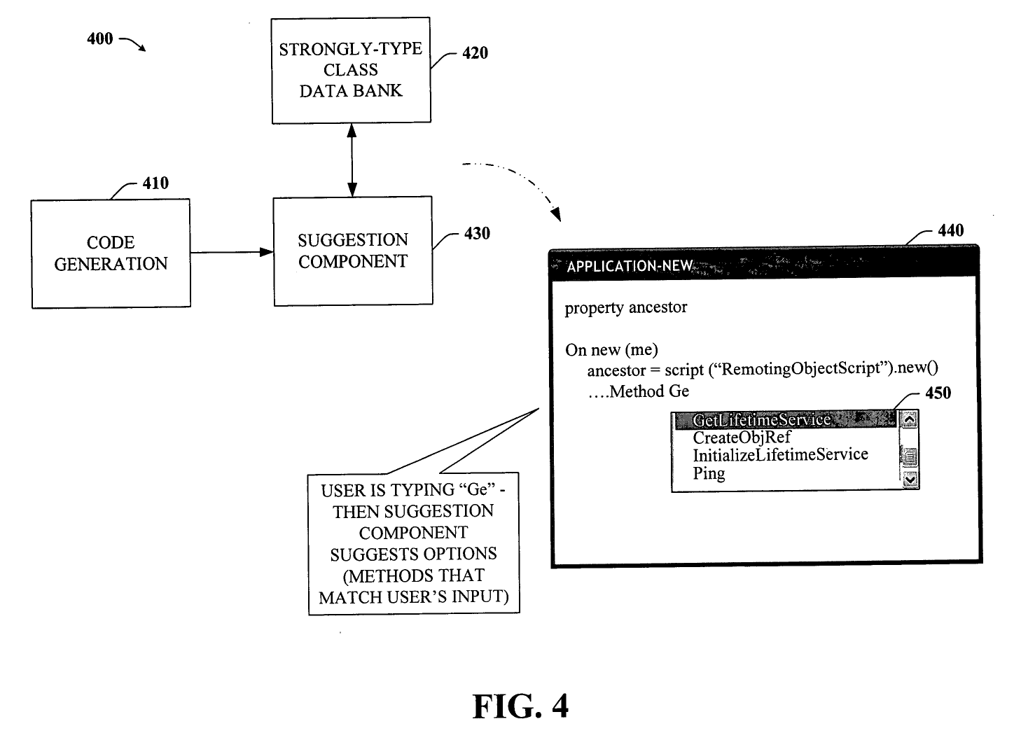

Moving on to FIG. 4, there is illustrated a schematic block diagram of a test coding system 400 that can facilitate developers or testers when writing or generating code 410 for a particular application or program. The system 400 can recognize and employ a strongly-typed data bank 420 that can be easily and readily accessed by a suggestion component 430. The suggestion component 430 can provide assistance to the developer or tester when coding an application in a few different ways.

In one approach, the suggestion component can provide a list of possible options to choose from after the user has typed at least the first character of a key word or phrase. The keywords or phrases can be maintained and learned from the data bank 420. The list can pop up on the user's screen in the form of a drop-down list, whereupon the user can easily make a selection or ignore the suggestions and type in another entry.

Alternatively, the suggestion component 430 can operate in a smart manner and assess what type of code the user is entering based in part on the previously entered data (e.g., the surrounding words or phrases). To better illustrate this approach, Window 440 for APPLICATION-NEW is provided. As can be seen in the Window 440, the user has typed a few lines of code relating to inheritance—including the text “RemotingObjectScript”. As the user types “Ge” in the next line, the drop down list 450 appears on the screen. Based on the RemotingObjectScript text observed just above this line of code, the suggestion component 430 can suggest at least one available method associated with the strongly-typed RemotingObject class—which can be stored in and/or retrieved from the data bank 420. The drop down list 450 can also have listed all appropriate words beginning with “Ge” depending on how the suggestion component is set up by the user. The user can highlight the desired choice and the desired choice can automatically populate the desired lines of the code. The suggestion component can be invoked when typing recognizable text related to classes, properties, methods, and the like or to a lesser or greater extent as determined by the user.

The suggestion component 430 can also provide its suggestions by completing a word for the user only after at least the first character is typed. Of course, the user can ignore the suggestion or agree to it. Since the suggestion component 430 can concentrate on and provide suggestions for the more meaningful portions of the code, consistency between coded applications can be optimized. In addition, the number of errors received when the code is compiled can be substantially reduced since the user is provided with only the available or most probable options; thus, resulting in fewer syntax and semantic errors.

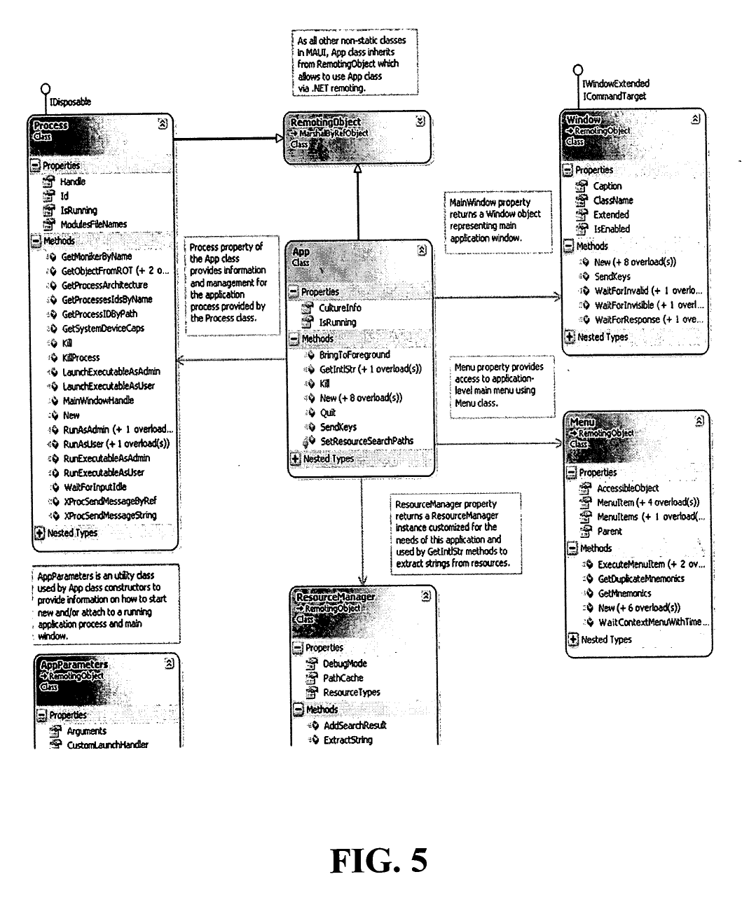

FIGS. 5-7 represent exemplary diagrams of various types of strongly-typed classes or controls that facilitate driving the automation of UI components. Each type of control can include one or more strongly-typed classes. The diagrams also indicate the many different relationships between the classes within each control. For example, in FIG. 5, a strongly-typed class referred to as App class is depicted. The App class is often the starting point for most automation test cases and applications. It provides automation abstraction for a UI application running as an operating system process which owns such UI components as a main application window and menu. More complicated application classes can inherit from the App class and customize its behavior to serve the needs of a particular automation domain. It should be appreciated that portions of the AppParameters class and ResourceManager class have been truncated for brevity.

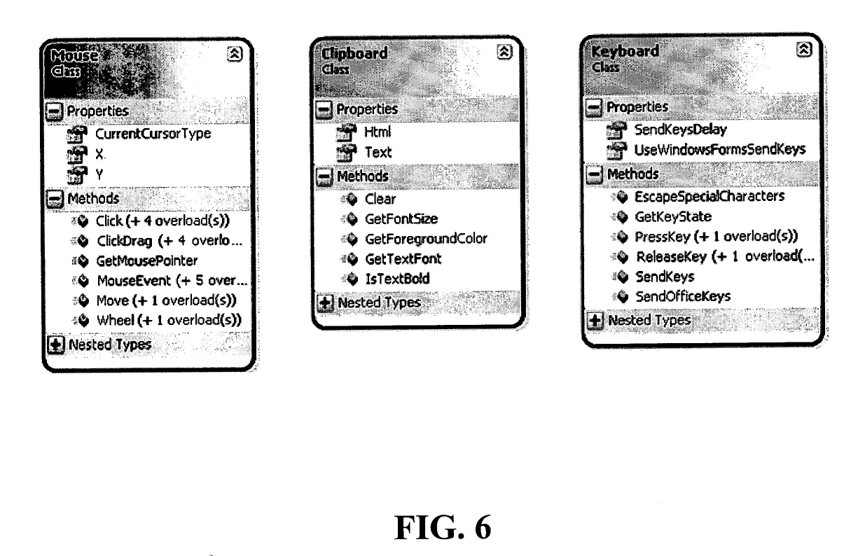

In FIG. 6, there are illustrated three exemplary classes which provide control, access, and automation of the most important UI user input sources: mouse, keyboard, and system clipboard. Of course other input sources can be strongly-typed as well, however, because they are not as prevalent in many applications as these three apparently are, the desire or need to strongly-type them may be to a lesser degree.

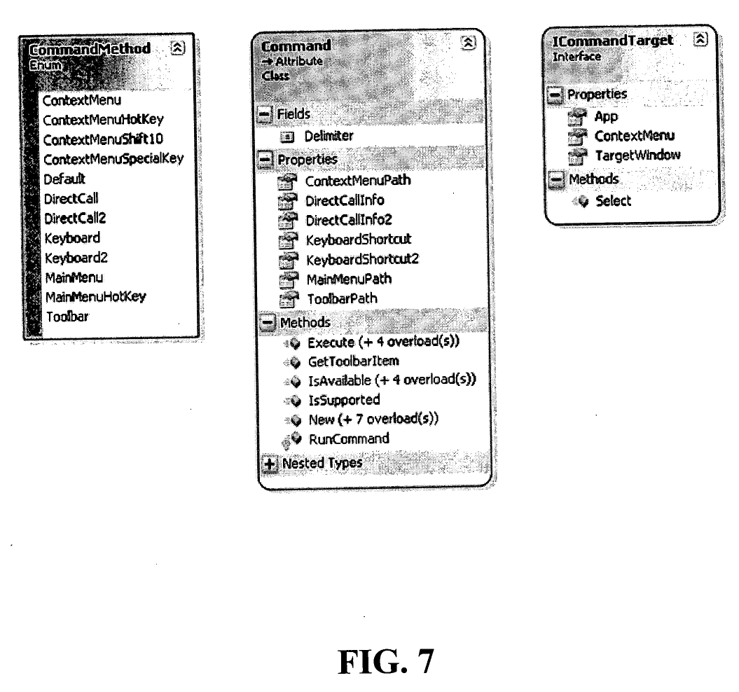

Turning to FIG. 7, there is depicted an exemplary Command class. The Command class represents an abstraction of some UI action which is available via main menu, context menu, toolbar, keyboard, and/or other ways in some applications. Commands are invoked on targets for which ICommandTarget interface serves as an automation abstraction. CommandMethod enum, which is passed to Command class methods such as Execute and IsSupported, defines which way a command invocation is considered.

As can be seen by FIGS. 5-7, each of the controls associates with one or more strongly typed classes, which can serve as building blocks. The building blocks can be used in any combination to automate any kind of application. Furthermore, these building blocks are designed to be used to create new classes (e.g., via composition or by serving as base classes) that are “strongly-typed” to specific elements within a given application. Fundamentally these strongly-typed classes encapsulate application-specific logic such as how to open a dialog, or how to find a button on the dialog and also provide a complete set of methods/object model for interacting with various types of common UI. The building blocks also establish some basic types or classifications of UI elements (e.g., dialogs, applications, controls, etc.) and provide a consistent set of extension points and object modeling across common groups of elements.

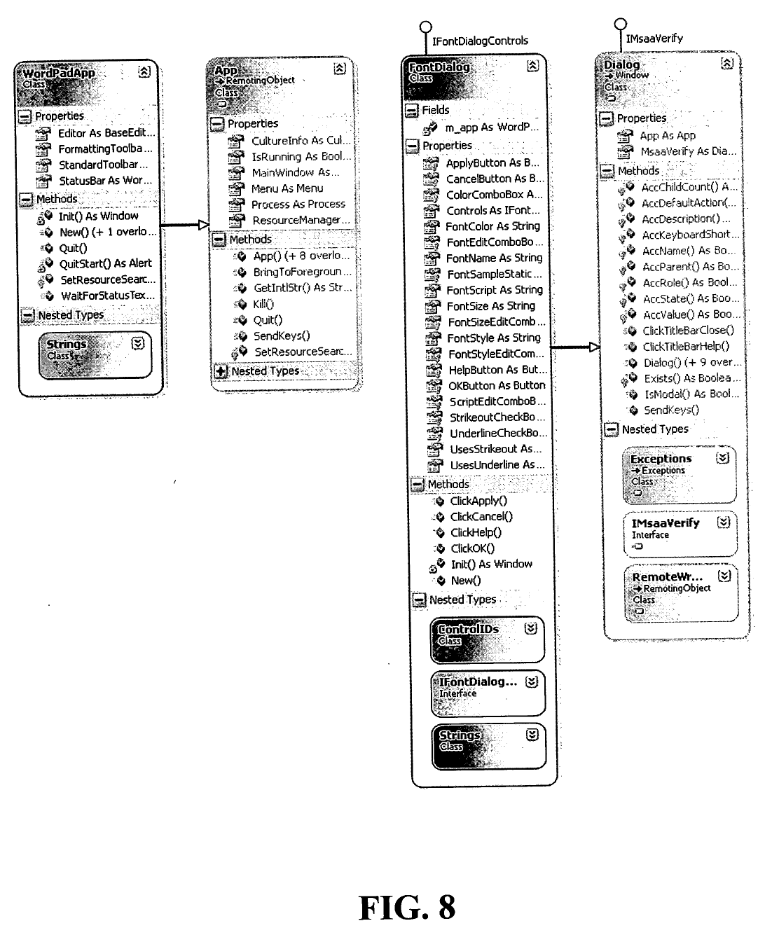

Looking now at FIG. 8, observe how the framework as described hereinabove can be employed to automate a word processor program—generically named ExPad. Suppose that ExPad is composed of numerous UI elements: a main window, editor, main menu, numerous dialogs, toolbars, status bar, etc. To begin automating ExPad, a testcase initially needs to start the application. In order to start ExPad via the framework, the App class can be invoked or employed. This class is designed to represent a typical desktop application. As such, the App class has methods that correspond to common UI elements found in desktop applications. For example, most applications contain menu bar. Accordingly, the App class includes a property for MainMenu that encapsulates the logic required to find an application's main menu. This MainMenu property can find and return an instance of a MainMenu class from the framework that, once attached, can then interact with a main menu and effectively automate the application's menus.

In addition, the App class can be used generically to launch any executable by using a non-attaching constructor and specifying the path to any executable file. While the class contains logic that can work to generically start and drive many apps, the class is designed to serve as a base class and can be extended to create a new “ExPadApp.” This new class can override some of the functionality of the base “App” class and add information specific to ExPad (e.g., logic to discover the path to ExPad on a given computer) and additional properties for ExPad specific elements not common to other applications (e.g., an editor, toolbar or a specific dialog). Testcases can then be written against this strongly-typed “ExPadApp” without supplying information that would normally be required by conventional practices to launch the application or to drive the menus, toolbars, etc.

Similarly, the framework contains a Dialog class that can be extended to map to a specific dialog within ExPad. The Dialog class, much like the App class, encapsulates code to deal with common dialog functionality (e.g., determining if a dialog is model or dismissing a dialog). As demonstrated in FIG. 8, the Font dialog within ExPad is represented by deriving from the base dialog class and adding additional methods to expose all of the controls on the dialog. In the case of the Font dialog, there are properties for the buttons, combo-boxes, and other controls. In a typical application, each of the dialogs in the application would be created as the Font dialog.

Various methodologies in accordance with the subject invention will now be described via a series of acts, it is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

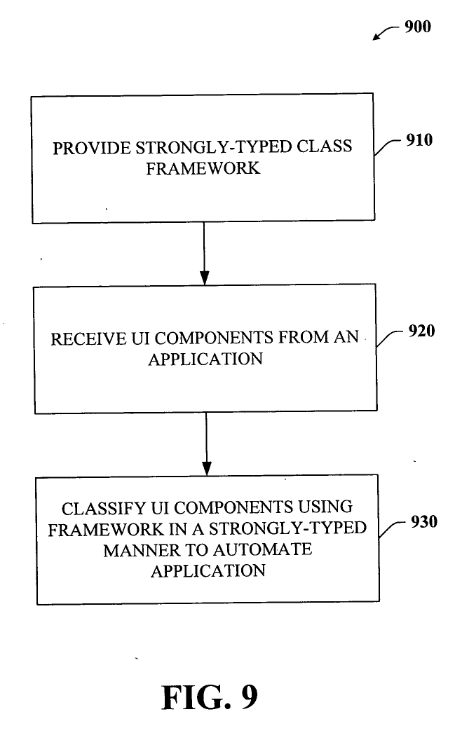

Referring now to FIG. 9, there is illustrated a flow diagram of an exemplary process 900 that facilitates classifying UI components for an application in a strongly-typed manner based at least in part upon the subject strongly-typed class framework. The process 900 involves providing a strongly-typed class framework at 910 which can assist in the automation of an application under test. At 920, UI components from the application can be received. These various UI components can then be classified in a strongly-typed manner based at least in part on the strongly-typed class framework to automate the application at 930. Thus, the UI components can be linked to one or more classes already present in the framework. Alternatively, new strongly-typed classes can be generated that are derived from the base classes.

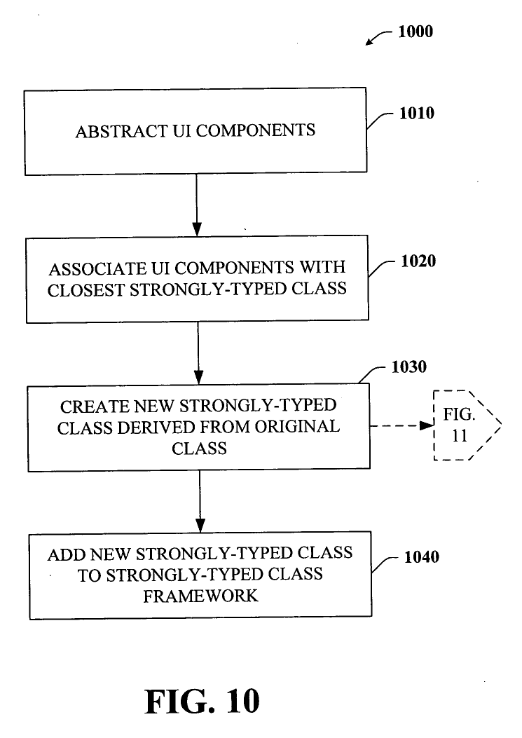

Turning to FIG. 10, there is illustrated a flow diagram of an exemplary process 1000 that facilitates classifying UI components for an application in a strongly-typed manner based at least in part upon a provided strongly-typed class framework. The process 1000 can begin with abstracting one or more UI components from the application under test at 1010. At 1020, the UI components can be associated with the closest matching strongly-typed classes in the framework. Following therefrom, new or customized strongly-typed classes can be created at 1030 as needed depending on the functionalities of the UI components. At 1040, the new strongly-typed classes can be added to the framework. It should be appreciated that the new derived classes can include methods that differ from or override one or more methods in the original, base class.

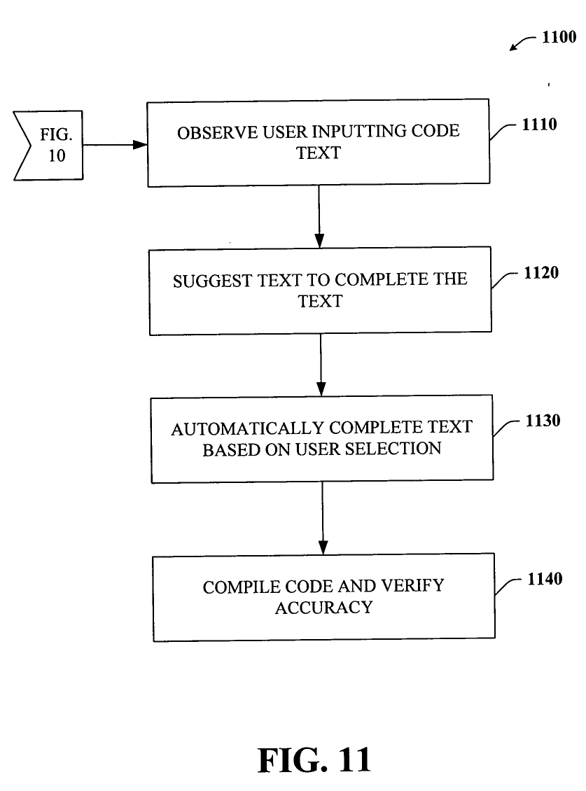

Once a new class is created, the code corresponding to that class can be written such as by a tester. In FIG. 11, an exemplary process 1100 demonstrates how code writing can be aided by employment of a strongly-typed class framework. For example, imagine that the process 1100 can observe a user inputting code text at 1110. At 1120, text can be suggested to the user as the user types the few beginning characters of a word or phrase. Suggested text can be provided where and when appropriate to reduce the number of syntax or semantic errors. Thus, the text can be automatically completed according to the user's selection at 1130. It should be appreciated that the user may ignore or turn off this feature as desired. The kinds of suggested text can be determined by looking at the first few letters typed in by the user or by analyzing the surrounding words and phrases to identify the context of the code. To do so, the process 1100 can be trained to learn particular associations. Furthermore, suggestions can be drawn from the information maintained in a data store comprising the strongly-typed class framework.

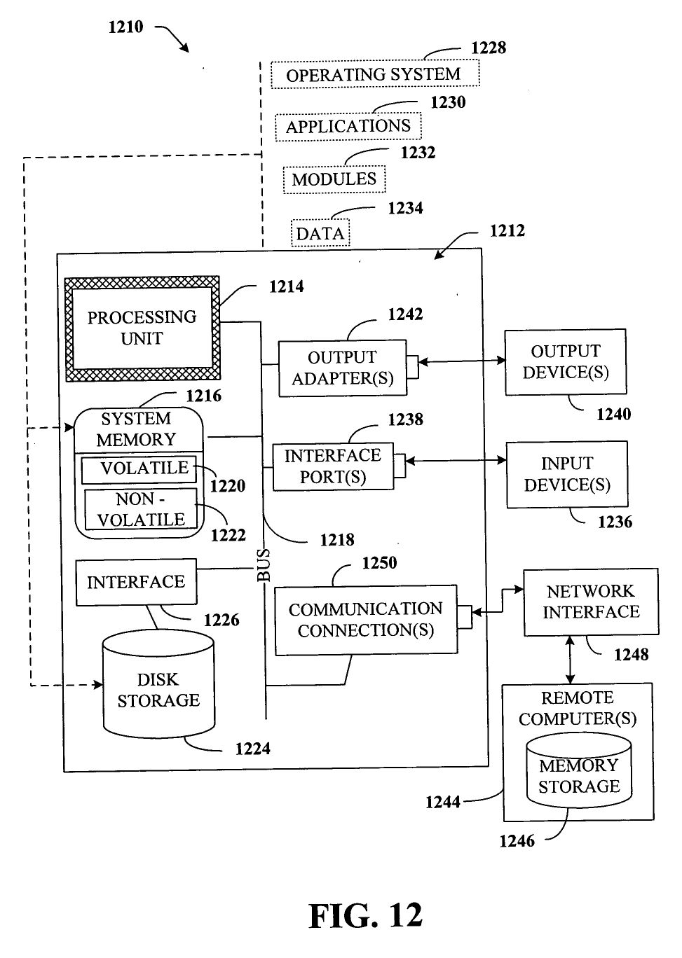

In order to provide additional context for various aspects of the subject invention, FIG. 12 and the following discussion are intended to provide a brief, general description of a suitable operating environment 1210 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1210 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 12, an exemplary environment 1210 for implementing various aspects of the invention includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/nonremovable, volatile/nonvolatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the subject invention can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers among other output devices 1240 that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates automation of an application comprising:
a base set of strongly-typed classes;
a correlation component that correlates one or more UI components to at least a subset of the strongly-typed classes; and
a building component that creates at least one new strongly-typed class based on at least one of the subset of strongly-typed classes to facilitate automating the one or more UI components in a strongly-typed manner.

2. The system of claim 1, the set of strongly-typed classes comprise a plurality of properties and methods organized according to the respective strongly-typed classes.

3. The system of claim 1, further comprising an abstraction component that abstracts the one or more UI components to yield one or more abstracted objects to facilitate the correlation component.

4. The system of claim 3, the one or more abstracted objects bind to the corresponding one or more UI components when the abstracted object is being constructed.

5. The system of claim 1, the one or more UI components are from an application under development or test.

6. The system of claim 1, the at least one new strongly-typed class created by the building component is derived from at least one of the base set of strongly-typed classes.

7. The system of claim 1, further comprising a code verification indicator that alerts a user when written code based on the at least one new strongly-typed class comprises at least one error at compile time.

8. The system of claim 1, further comprising an AI component that learns functional and non-functional associations between one or more UI components and the base strongly-typed classes to mitigate errors when compiling code corresponding to the at least one new strongly-typed class.

9. The system of claim 1, wherein the new strongly-typed class is added to the base set of strongly-typed classes, from which newer strongly-typed classes can be derived.

10. The system of claim 1, further comprising a modification component that customizes an existing strongly-typed class to form a new strongly-typed class derived therefrom.

11. The system of claim 10, the modification component allows at least one base behavior associated with a base strongly-typed class to be overridden by at least one new behavior in the new strongly-typed class.

12. The system of claim 1, further comprising a suggestion component that suggests text suitable to complete a user's partially entered text while writing code, thereby mitigating syntax or semantic coding errors.

13. The system of claim 12, the suggestion component examines the partially entered text as well as surrounding text to determine suggestions that make sense and are relevant to a particular line of the code.

14. The system of claim 1 is a constructed based system that binds an abstracted object and its corresponding UI component when the abstracted object is being constructed.

15. The system of claim 14, wherein access to one or properties of the UI component being abstracted is obtained when the abstracted object's constructor is completed.

16. The system of claim 1 further comprising a data bank that stores the set of strongly-typed classes.

17. A method that facilitates automating one or more UI components in a computer-based application comprising:
providing a strongly-type class framework; and
classifying the one or more UI components based at least in part upon the framework in a strongly-typed manner.

18. The method of claim 17, further comprising creating one or more new strongly-typed classes that are derived at least in part from the framework.

19. The method of claim 17, further comprising augmenting the framework by adding the one or more new strongly-typed classes to it.

20. The method of claim 17, the strongly-typed class framework comprises a plurality of strongly-typed classes, wherein at least a subset of the classes comprise one or more methods that correspond to UI components found in the application.

21. The method of claim 17, further comprising abstracting the one or more UI components from the application; and correlating each UI component with its closest match to at least one strongly-typed class in the framework.

22. The method of claim 21, wherein abstracting the one or more UI components yields construction of one or more abstracted objects corresponding, the construction of which occurs simultaneously with binding the abstracted object to its corresponding UI component.

23. The method of claim 17, further comprising modifying at least one base strongly-typed class in the framework to create a new strongly-typed class derived therefrom.

24. The method of claim 23, the new strongly-typed class overrides at least one behavior of the base strongly-typed class.

25. The method of claim 23, further comprising writing code to correspond to at least one of the new strongly-typed class and classifications of the one or more UI components.

26. The method of claim 25, further comprising suggesting at least one of keywords or phrases based at least in part on a user's typed input to facilitate more accurate coding of the application.

27. The method of claim 23, further comprising verifying that the code runs as desired.

28. A data packet adapted to be transmitted between two or more computer processes mitigating receipt of errors at compile time of a coded application comprising: information associated with classifying a plurality of UI components abstracted from a computer based application in a strongly-typed manner based at least in part on a strongly-typed class framework.

29. A computer readable medium having stored thereon the computer executable components of the system of claim 1.

30. A system that facilitates automating one or more UI components in a computer-based application comprising:
means for providing a strongly-type class framework; and
means for classifying the one or more UI components based at least in part upon the framework in a strongly-typed manner.
